(19) United States
(12) Patent Application Publication
(10) Pub. No.: US 2005/0102434 A1
(43) Pub. Date: May 12, 2005

(54) Method of processing an ATAPI command including a plurality of status notifications

(76) Inventor: Hua-Gen Guo, Su-Chou City (CN)

Correspondence Address: NORTH AMERICA INTERNATIONAL PATENT OFFICE (NAIPC), P.O. BOX 506, MERRIFIELD, VA, 22116, US

(21) Appl. No.: 10/904,268

(22) Filed: Nov. 2, 2004

(30) Foreign Application Priority Data
Nov. 6, 2003 (TW) 092131055

(51) Int. Cl. G06F 3/00

(52) U.S. Cl. 710/1

(57) ABSTRACT

A method of processing an ATAPI command including a plurality of status notifications. The method includes a host sending a command to an electronic device, and the electronic device returning data corresponding to the status notification having the highest priority of the command, and removing the status notification, which has just been returned, from the command to form a temporary command. When the electronic device receives the command again, the electronic device returns data corresponding to the status notification having the highest priority of the temporary command, and removes the status notification, which has just been returned, from the temporary command.

### BACKGROUND OF INVENTION

1. Field of the Invention

The present invention relates to a method of processing an ATAPI command, and more particularly, to a method of processing an ATAPI command including a plurality of status notifications.

2. Description of the Prior Art

The ATAPI (Advanced Technology Attachment Packet interface) is an interface between a computer host and an optical disk drive (or a hard disk drive). This interface adopts a 16 bit ISA bus, and supports parallel input/output functions. In addition, since ATAPI is developed from ATA (advanced technology attachment), ATAPI also supports all IDE functions.

An ATAPI command “0×4A” can be used to read status notifications of an optical storage device (for example a CD-ROM, a CD-RW, or a DVD). According to ATAPI protocol, the command “0×4A” only executes a status notification one time, and thus the optical disk drive returns the status notification having the highest priority to the host.

Please refer to FIG. and FIG. 2. FIG. 1 is a schematic diagram of a host 10 connected to an optical disk drive 16 via an ATAPI interface 14. FIG. 2 is a definition table of a “0×4A” command notification class request. The “0×4A” command notification class request includes a plurality of status notifications, and the status notification having a larger class number has higher priority. The class numbers 0 and 7 are reserved bits, while number 1 is operational change request, number 2 is power management, number 3 is external request, number 4 is media, number 5 is multi host, and number 6 is device busy. An illustrative example of a conventional algorithm when executing the command “0×4A” is listed as follows:

```
if(cmd(4)&0x02)
send2host(v1);//return operational change request to the host 12
else if(cmd(4)&0x04)
    send2host(v2);//return power management to the host 12
else if(cmd(4)&0x08)
    send2host(v3);//return external request to the host 12
else if(cmd(4)&0x10)
    send2host(v4); //return media to the host 12
else if(cmd(4)&0x20)
    send2host(v5);//return multi host to the host 12
else if(cmd(4)&0x40)
    send2host(v6);//return device busy to the host 12
```

where cmd(4) means the command that the host 12 sends to the optical disk drive 16 for requesting a notification class request, and send2host means the value that the optical disk drive 16 returns to the host 12.

If the host 12 makes a command to the optical disk drive 16 for requesting a plurality of status notifications, the host 12 can only obtain data corresponding to the status notification with the highest priority according to the conventional algorithm. Since the host 12 cannot receive all the necessary status notifications, the host 12 will send the same command repeatedly to the optical disk drive 16. However, the host 12 never succeeds in obtaining data corresponding to the status notifications with a lower priority according to the conventional algorithm no matter how many times it tries. In other words, the conventional algorithm fails to process the command, which requests more than one multiple status notification. For example, cmd(4)=0×12 means that the host 12 makes a request to the optical disk drive 16 for the status notifications “operational change request” and “media”. However, since the priority of the status notification “operational change request” is higher than the priority of the status notification “media”, the optical disk drive 16 ignores the request for the status notification “media” and only returns data corresponding to the status notification “operational change request” to the host 12. The host 12 will give another try when the request for the status notification “media” is not fulfilled again and again, but data corresponding to the status notification “media”, which has a lower priority, will never be obtained. Thus, the program fails to continue executing.

### SUMMARY OF INVENTION

It is therefore a primary objective of the present invention to provide a method of processing an ATAPI command including a plurality of status notifications for solving the above problem.

According to the claimed invention, a method of processing an ATAPI command including a plurality of status notifications is disclosed. The method comprises a host sending a command to an electronic device, and the electronic device returning data corresponding to the status notification having the highest priority of the command, and removing the status notification, which has just been returned, from the command to form a temporary command. When the electronic device receives the command again, the electronic device returns data corresponding to the status notification having the highest priority of the temporary command, and removes the status notification, which has just been returned, from the temporary command.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a host connected to an optical disk drive via an ATAPI interface.

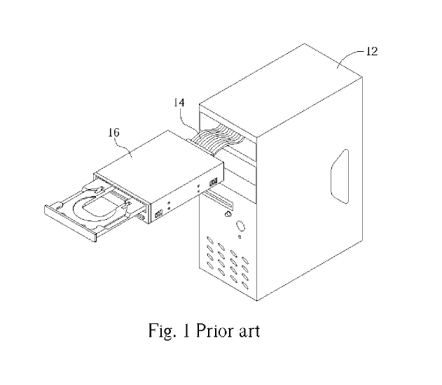

FIG. 2 is a definition table of a “0×4A” command notification class request.

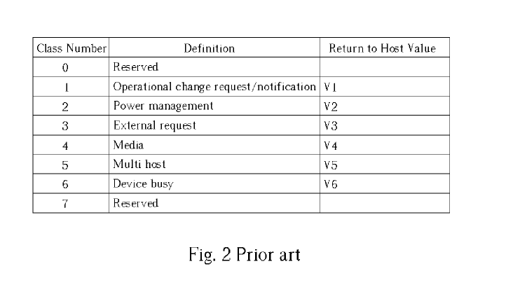

FIG. 3 is a flow chart illustrating an algorithm of the present invention.

### DETAILED DESCRIPTION

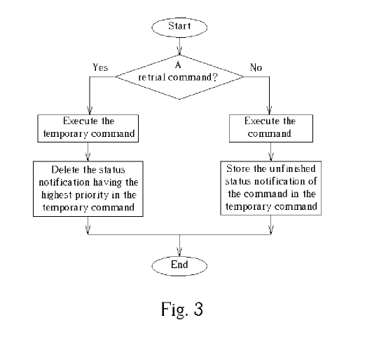

Please refer to FIG. 3. FIG. 3 is a flow chart illustrating an algorithm of the present invention. As shown in FIG. 3, the algorithm of the present invention uses a temporary command to store the unfinished notifications of a command having multiple status notifications. A command is determined to be a retrial command or not before being executed. In this determination procedure, two conditions are considered. First, it is determined if the current command is identical to the previously executed command. Second, it is determined if the temporary command includes any unexecuted status notifications. In case these two conditions sustain, i.e., the current command is a retrial command, then the current command is ignored. Instead, the temporary command is executed, and the status notification with the highest priority is deleted after executing the temporary command. If any one of the two conditions does not sustain, i.e., the current command is new, then the current command is executed. If the current command includes a plurality of status notifications, the unexecuted status notifications are stored in the temporary command. An embodiment of the algorithm according to the present invention is shown as follows:
b_cmd4=0;//previous command
b_cur=0;//temporary command

UCHAR i=0;

if((b_cmd4==cmd(4))&& b_cur)//determine if current command is a

retrial command

cmd(4)=b_cur;
else
b_cur=b_cmd4=cmd(4);
while(((b_cur&0x01)==0) && (i<7))//delete the status notification

with the highest priority in the temporary command

{
b_cur=b_cur>> 1;
i++;
}
b_cur= cmd(4)&˜(1 <<i);
if(cmd(4)&0x02)
send2host(v1);//return operational change request to the host 12
else if(cmd(4)&0x04)
send2host(v2);//return power management to the host 12
else if(cmd(4)&0x08)
send2host(v3);//return external request to the host 12
else if(cmd(4)&0x10)
send2host(v4); //return media to the host 12
else if(cmd(4)&0x20)
send2host(v5);//return multi host to the host 12
else if(cmd(4)&0x40)
send2host(v6);//return device busy to the host 12
else
send2host(error);//return error to the host 12

Some examples are given herein to illustrate how the host 12 sends the command, and how the optical disk drive 16 returns the command according to the algorithm of the present invention. For convenience, all uncritical parameters are expressed as “*”, and all initial values are presumed 0 (i.e. the initial values of b_cmd4 and b_cur are 0).

### EXAMPLE 1

The host 12 sends a request to the optical disk drive 16 for status notification v2 (power management), and thus the host 12 sends a command (0×4A,*,*,0×04,*,*,*,*,*,*,*,*) to the optical disk drive 16.

Variable status:
cmd(4): 0×04
b_cmd4: 0
b_cur: 0
since b_cmd4 !=cmd(4) and b_cur==0,
then b_cur=b_cmd4=cmd(4);
after the while loop is executed, i=2,
execute b_cur=cmd(4)&˜(1<<i), then b_cur=0;
since cmd(4) is 0×04, execute send2host(v2),
after the command is end, variable status becomes
b_cmd4: 0×04
b_cur: 0

### EXAMPLE 2

The host 12 needs status notification v2 (power management), and thus sends a command (0×4A,*,*,0×04,*,*,*,*,*,*,*,*) to the optical disk drive 16.

Variable status:
cmd(4): 0×04
b_cmd4: 0×04
b_cur: 0
though b_cmd4==cmd(4), but b_cu r==0,
therefore b_cur=b_cmd4=cmd(4);
after the while loop is executed, i=2,
execute b_cur=cmd(4)&˜(1<<i), then b_cur=0;
since cmd(4) is 0×04, execute send2host(v2),
after the command is end, variable status becomes
b_cmd4: 0×04
b_cur: 0

### EXAMPLE 3

The host 12 sends a request to the optical disk drive 16 for status notification v4 (media), and thus the host 12 sends a command (0×4A,*,*,0×10,*,*,*,*,*,*,*,*) to the optical disk drive 16.

Variable status:
cmd(4): 0×10
b_cmd4: 0×04
b_cur: 0
since cmd(4) !=b_cmd4 and b_cu r==0,
then b_cur=b_cmd4=cmd(4);
after the while loop is executed, i=4,
execute b_cur=cmd(4)&˜(1<<i), then b_cur=0;
since cmd(4) is 0×10, execute send2host(v4),
after the command is end, variable status becomes
b_cmd4: 0×10
b_cur: 0

It can be seen from the above three examples that the algorithm of the present invention can implement all the functions that the conventional algorithm can do. The following examples will exhibit more advantages of the algorithm of the present invention.

### EXAMPLE 4

The host 12 sends a request to the optical disk drive 16 for status notifications v4 and v1 (media and operational change request), and thus the host 12 sends a command (0×4A,*,*,0×12,*,*,*,*,*,*,*,*) to the optical disk drive 16.

Variable status:
cmd(4): 0×12
b_cmd4: 0×10
b_cur: 0
since cmd(4) !=b_cmd4 and b_cu r==0,
then b_cur=b_cmd4=cmd(4);
after the while loop is executed, i=1,
execute b_cur=cmd(4)&˜(1<<i), then b_cur=0×10;
since cmd(4) is 0×12, execute send2host(v1) due to priority,
after the command is end, variable status becomes
b_cmd4: 0×12
b_cur: 0×10

### EXAMPLE 5

The host 12 requested status notifications v4 and v1 (media and operational change request), but only obtained data corresponding to status notification “operational change request”. For obtaining data corresponding to all necessary status notifications, the host 12 sends a command (0×4A,*,*,0×12,*,*,*,*,*,*,*,*) to the optical disk drive 16 again.

Variable status:
cmd(4): 0×12 ∘
b_cmd4: 0×12
b_cur: 0×10
since cmd(4)==b_cmd4 and b_cur !=0,
then cmd(4)=b_cur;
after the while loop is executed, i=4,
execute b_cur=cmd(4)&˜(1<<i), then b_cur=0×00;
since cmd(4) is 0×10, execute send2host(v4),
after the command is end, variable status becomes
b_cmd4: 0×12
b_cur: 0
so far the host 12 obtains data corresponding to all the necessary status notifications. If the host 12 sends the same command (0×4A,*,*,0×12,*,*,*,*,*,*,*,*) to the optical disk drive 16, the optical disk drive 16 will repeat the procedures of example 4 and example 5.

### EXAMPLE 6

The host 12 sends a request to the optical disk drive 16 for status notifications v1, v4, and v6 (device busy, media, and operational ch0×4A), and thus sends a command (0×4A,*,*,0×52,*,*,*,*,*,*,*,*) to the optical disk drive 16.

Variable status:
cmd(4): 0×52 ∘
b_cmd4: 0×12
b_cur: 0×0
since cmd(4) !=b_cmd4 and b_cu r==0,
then b_cur=b_cmd4=cmd(4);
after the while loop is executed, i=1,
execute b_cur=cmd(4)&˜(1<<i), then b_cur=0×50;
since cmd(4) is 0×52, execute send2host(v1) due to priority,
after the command is end, variable status becomes
b_cmd4: 0×52
b_cur: 0×50

### EXAMPLE 7

The host 12 requested status notifications v1, v4, and v6 (device busy, media, operational change request), but only obtained data corresponding to status notification v1 (operational change request). For obtaining data corresponding to all necessary status notifications, the host 12 sends the command (0×4A,*,*,0×52,*,*,*,*,*,*,*,*) to the optical disk drive 16 again.

Variable status:
cmd(4): 0×52 ∘
b_cmd4: 0×52
b_cur: 0×50

since cmd(4)==b_cmd4 and b_cur !=0,
then cmd(4)=b_cur;
after the while loop is executed, i=4,
execute b_cur=cmd(4)&˜(1<<i), then b_cur=0×40;
since cmd(4) is 0×50, execute send2host(v4) due to priority,
after the command is end, variable status becomes:
b_cmd4: 0×52
b_cur: 0×40

### EXAMPLE 8

The host 12 requested status notifications v1, v4, and v6 (device busy, media, operational change request), but only obtained data corresponding to status notification v1 and v4 (operational change request and media). For obtaining data corresponding to all necessary status notifications, the host 12 sends the command (0×4A,*,*,0×52,*,*,*,*,*,*,*,*,) to the optical disk drive 16 again.

Variable status:
cmd(4): 0×52 ∘
b_cmd4: 0×52
b_cur: 0×40
since cmd(4)==b_cmd4 and b_cur !=0,
then cmd(4)=b_cur;
after the while loop is executed, i=6,
execute b_cur=cmd(4)&˜(1<<i), then b_cur=0×00;
since cmd(4)is 0×40, execute send2host(v6),
after the command is end, variable status becomes
b_cmd4: 0×52
b_cur: 0×00
so far the host 12 has obtained data corresponding to all the necessary status notifications

It can be seen from example 4 to example 8 that the algorithm of the present invention can implement all of the functions (a command having one status notification) that the conventional algorithm can do, and functions (a command having multiple status notifications) that the conventional algorithm cannot fulfill as well.

In comparison with the prior art, the present invention provides a method of processing an ATAPI command including a plurality of status notifications. According to the algorithm of the present invention, the host can obtain data corresponding to all the status notifications contained in a command after sending the same command for several times. Consequently, the host can communicate with the optical disk drive efficiently.

Those skilled in the art will readily appreciate that numerous modifications and alterations of the device may be made without departing from the scope of the present invention. Accordingly, the above disclosure should be construed as limited only by the metes and bounds of the appended claims.

1. A method of processing an ATAPI command including a plurality of status notifications, the method comprising:
a host sending a command to an electronic device, the command having a plurality of status notifications with different priorities;
the electronic device returning data corresponding to a status notification having a highest priority of the command, and removing the status notification, which has just been returned, from the command to form a temporary command; and
when the electronic device receives the command again, the electronic device returning data corresponding to a status notification having a highest priority of the temporary command, and removing the status notification, which has just been returned, from the temporary command.

2. The method of claim 1 wherein the command is end if there are no remaining status notifications in the temporary command.

3. The method of claim 1 wherein the host is a personal computer (PC).

4. The method of claim 1 wherein the electronic device is an optical storage device.

5. The method of claim 1 wherein the plurality of status notifications comprises operational change request, power management, external request, media, multi host, and device busy.

6. The method of claim 1 wherein the method further comprises using a first parameter for storing the temporary command.

7. The method of claim 1 wherein the method further comprises using a second parameter for storing the command sent by the host, so that the electronic device is capable of determining if a same command is received.

8. An electronic device for implementing the method of claim 1.
